(19) United States
(12) Patent Application Publication
(10) Pub. No.: US 2026/0079818 A1
(43) Pub. Date: Mar. 19, 2026

(54) CODE PERFORMANCE OPTIMIZER FRAMEWORK

(71) Applicant: SAP SE, Walldorf (DE)

(72) Inventors: Arun Mysore CHAMARAJU, Bangalore (IN); Savan RAI, Bangalore (IN); Vinutha Yediyur VARADARAJALYENGAR, Bangalore (IN)

(21) Appl. No.: 18/889,919

(22) Filed: Sep. 19, 2024

(51) Int. Cl. G06F 11/36

(52) U.S. Cl. CPC G06F 11/364

(57) ABSTRACT

According to some embodiments, systems and methods are provided including receiving a block of code including a code candidate; inserting at least one break point in the block; executing a debugger tool with the code candidate, wherein the debugger tool is included in a pre-production environment; generating a code replacement for the code candidate; replacing the code candidate with the code replacement; automatically embedding a code replacement script in the code block with the code replacement; executing the code block including the code replacement script in the debugger tool, wherein execution of the code block outputs at least a code replacement trace result; comparing the code replacement trace result to a code candidate trace result; and based on the comparison, transmitting the code block including the code replacement to a development environment. Numerous other aspects are provided.

### BACKGROUND

Application developers create new software applications and fix existing software applications. During the creation and fixing processes, different environments are typically used to facilitate this development/fixing. Each environment may be an isolated and controlled environment that serves a specific purpose and helps ensure that changes to the application are tested and validated before being deployed to the production environment where they will impact end users. A development environment, for example, is where developers work on building and modifying applications including writing and testing code, creating new features and creating data models and processes. A pre-production environment is a staging area where developers and quality assurance teams test and validate software in an environment that closely mirrors the production environment before the application is deployed to production. For example, the pre-production environment may match hardware, software configurations and network configurations of the production environment. The pre-production environment serves as a transitional stage between the development environment and the production environment. The pre-production environment may include functional testing (e.g., unit testing, smoke testing, integration testing, regression testing) and non-functional testing (e.g., performance testing, performance tuning, load testing, stress testing, scalability testing) and user training with the goal of mitigating risks associated with deploying changes directly to the production environment and to ensure a smooth transition, reducing the risk of unexpected bugs, performance bottlenecks and security vulnerabilities. The production environment is where the live application operates and serves end users. The production environment is used by end users to access and interact with the application for their daily operations.

After the software is developed in the development environment, it is transmitted to the pre-production environment for testing, including performance testing. Performance testing is a non-functional software testing technique that determines how the stability, speed, scalability, and responsiveness of an application holds up under a given workload. In a case the performance testing indicates the software is performing below expectations, the software may be returned to the development environment for fine tuning. Once the changes are made in the development environment, the software is again transmitted to the pre-production environment for testing. The back-and-forth between the development and pre-production environment may include several iterations and is a tedious and time-consuming process.

Systems and methods are desired to make it easier to rectify performance deficiencies in software.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a block diagram of a prior art performance testing process.

FIG. 2 is a block diagram of an architecture according to some embodiments.

FIG. 3 is a flow diagram of a process according to some embodiments.

FIG. 4 is a user interface including a code candidate according to some embodiments.

FIG. 5 is a user interface including a breakpoint according to some embodiments.

FIG. 6 is a user interface including the optimization plug-in according to some embodiments.

FIG. 7 is a user interface including a trace comparison of before the code change and after the code change according to some embodiments.

FIG. 8 is a sequence diagram according to some embodiments.

FIG. 9 is a block diagram of a cloud-based architecture according to some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein. It should be appreciated that in development of any such actual implementation, as in any engineering or design project, numerous implementation-specific decisions must be made to achieve the developer’s specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

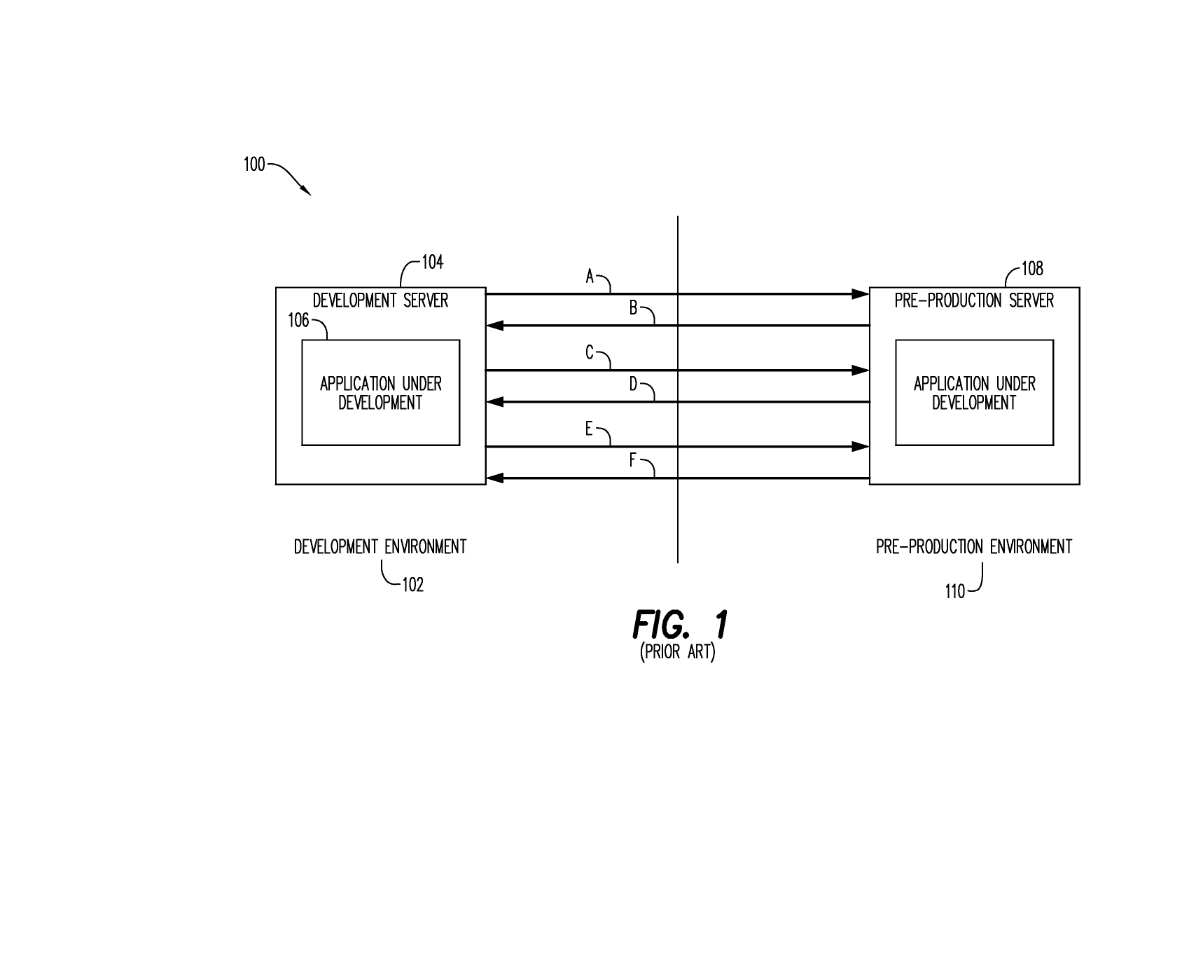

As described above, software applications are created by developers in a development environment. The development environment 102 includes various tools and frameworks to aid developers in writing code for new applications and features. For example, as shown in the architecture 100 of FIG. 1, the development environment 102 includes a development server 104 on which the developer (not shown) creates the application under development 106. After creation of the application under development 106 in the development environment 102, it is transmitted to a pre-production server 108 in a pre-production environment 110, as indicated by “A”. In the pre-production environment, a plurality of functional and non-functional tests may be applied to the application under development. For example, a functional test may be applied to the application under development to determine whether the functional requirements or specifications for the application are properly satisfied (e.g., verifying that each function of the application works in conformance with the requirement and specification). As another example, a non-functional performance test may be applied to the application under development to determine whether the application under development is performing in terms of speed, reliability and stability under varying workloads. With the performance test, a test case may be used to execute a performance scenario and output a measurement (e.g., duration). For example, the test case query took four seconds for execution, but the target is one second. In a case the application under development fails the tests, the application under test is transmitted from the pre-production server 108 in the pre-production environment 110 back to the development server 104 in the development environment 102, as indicated by “B”. The returned application under development may then be edited in an attempt to resolve the problem. Often in conventional systems, the developer may need to drill down further in the measurements to identify a location of the bottleneck and then analyze the specific code to propose edits. The edits are often based on the developer knowledge. After the developer edits the application under development 106, it is again transmitted from the development server 104 in the development environment 102 to the pre-production server 108 in the pre-production environment 110, as indicated by “C”. Again, the performance test may be performed and this edited application under development 106 may again fail the test, and return to the development server 104 for further editing, as indicated by “D”. The back and forth (e.g., again at “E” and “F”) between the development server and pre-production server may occur several times before the application under development passes the tests. This back and forth may be time consuming, may reduce the available bandwidth of the system, may reduce the availability of other resources, and may be limited by the knowledge of the developer.

To address these problems, a code performance optimizer framework or system provides for the optimization of under-performing code in an application without having to transmit the code to the development environment to address the under-performance. In one or more embodiments, the application includes a block of code and a portion of the block of code is identified as under-performing. In the pre-production environment the under-performing portion is marked in the block of code and a code replacement is generated. The code replacement may be generated by a Generative Artificial Intelligence (GenAI) element. The code replacement replaces the under-performing portion in the block of code. In the pre-production environment a performance test is executed for both the block of code with the under-performing portion and the block of code with the code replacement. The output of each performance test is compared to each other to determine whether block of code with the code replacement performs better than the block of code with the under-performing code portion. In a case the block of code with the code replacement does perform better, it is determined whether the block of code with the code replacement performs at a level to exceed a pre-set threshold. In a case the block of code with the code replacement performs at a level to exceed the pre-set threshold, the block of code with the code replacement is transmitted to the development environment for inclusion in the software application that will be transmitted to the production environment. In a case the block of code with the code replacement does not perform better, the code replacement may be marked and a second code replacement is generated. In a case a code replacement cannot be generated per a given parameter or cannot exceed the pre-set threshold (e.g., number of iterations, time spent generating a replacement, pre-defined difference in the performance metrics, etc.), an alert may be sent to the developer for manual intervention. Pursuant to embodiments, and in comparison to conventional systems, the code performance optimizer framework accelerates code change verification and performance assessment. Embodiments also provide for the streamlining of real-time detection of performance bottlenecks in the code; evaluation of outcomes; and the introduction of an automatic text generation enhancements to code. Another benefit provided by embodiments is improved network performance (e.g., by reducing an amount of network message bandwidth required to transmit the code between the development environment and the pre-production environment and/or storage required for the many iterations, and minimizing the processing needs of the system).

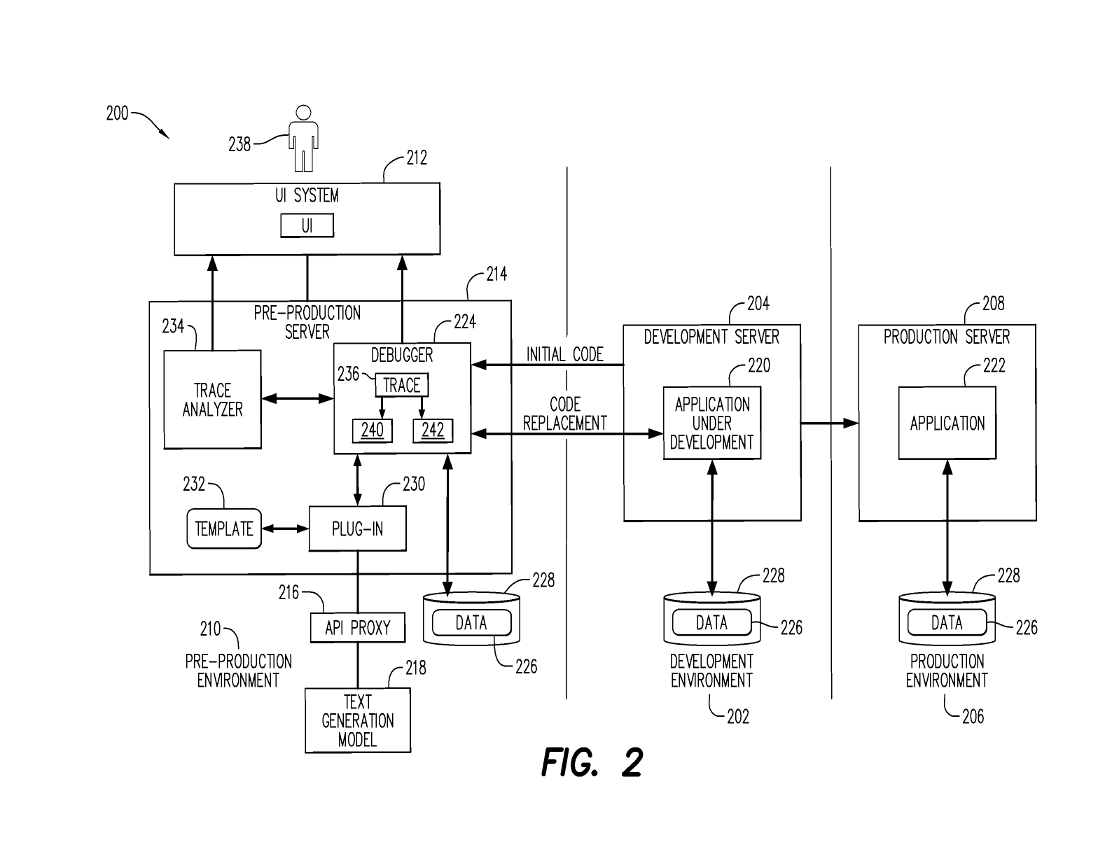

FIG. 2 is a high-level block diagram of a code performance optimizer framework or system architecture 200 according to some embodiments. The illustrated elements of system architecture 200 and of all other architectures depicted herein may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. In some embodiments, two or more elements of system architecture 200 are implemented by a single computing device, and/or two or more elements of system architecture 200 are co-located. One or more elements of system architecture 200 may be implemented using cloud-based resources, and/or other systems which apportion computing resources elastically according to demand, need, price, and/or any other metric. One or more components may be implemented as a cloud service (e.g., Software-as-a-Service, Platform-as-a-Service).

System architecture 200 includes a development environment 202 (including a development server 204), a production environment 206 (including an application server 208), and a pre-production environment 210 (including a user interface system 212, a pre-production server 214, an API proxy 216 and a text generation model 218).

The development server 204, production server 208 and pre-production server 214 may comprise one or more servers, virtual machines, clusters of a container orchestration system, etc. The development server 204, production server 208 and pre-production server 214 may provide an operating system, services, I/O, storage, libraries, frameworks, etc. to applications and other components executing therein.

The development environment 202 hosts the creation of an application under development 220 on the development server 204. It is noted that while reference is made to an application under development, the development environment 202 may also host development of a function, an update to an application, etc. The development environment 202 may be an integrated development environment, and the development server 204 may host tools for software development including, but not limited to, a source-code editor, build automation tools etc.

The production environment 206 is a real-time setting that hosts, on the production server 208, the latest versions of the application software or product that is made available as a live usable operation for the intended end users. The application under development 220 is no longer under development in the production environment 206 and is the application 222.

The application under development 220 being created in the development environment 202, the application 222 hosted by the production environment 206, and a debugger application 224 hosted by the pre-production environment 204, may comprise program code executable by a processing unit to provide functions to end users (not shown) based on coded logic and on data 226 stored in data store 228. Each of the environments may also include data 226 stored in data stores 228 for use with the application 222, the application under development 220, the debugger application 224, and any other application used by the servers in the respective environments. Data 226 may comprise tabular data stored in a columnar or row-based format, object data or any other type of data that is or becomes known. Data store 228 may comprise any suitable storage system such as database system, which may be partially or fully remote from development server 204, production server 208 and pre-production server 214, and may be distributed as is known in the art.

The pre-production server 214 of the pre-production environment 210 includes a debugger application 224, an optimizer plug-in element 230, prompt templates 232, and a trace-analyzer 234.

The debugger application (“debugger”) 224 may identify coding errors at various stages of development of the application under development 220. Pursuant to embodiments, the debugger 224, during execution thereof, goes through the code flow of the application under development 220 during runtime. Pursuant to some embodiments, the debugger 224, during execution hereof, goes through the flow of the block of code instead of the entire application under development during runtime. During execution of the debugger 224, a trace element 236 is also executing to follow and track the program’s flow and data progression as it travels through the executing application. The trace element 236 provides details of the execution plan for the application under development 220/code block and process timing details for the application under development 220. According to some embodiments, user 238 may interact with the debugger 224 (e.g., via a Web browser executing a front-end UI application associated with the debugger 224) to issue a request associated with data 226 for optimizing the application under development 220 according to embodiments, as described further below with respect to FIG. A request (e.g., execution of a test case, optimization of an application under development, etc.) may request data 226, a calculation using data 226, a particular visualization of data 226, and/or and other information that is or becomes known. To serve a received request, the debugger may generate queries of data 226 to retrieve required data, as well as use the optimizer plug-in element 230 and the prompt template 232. The elements of the pre-production server 214 may perform processing on data 226 prior to returning the data to user 238.

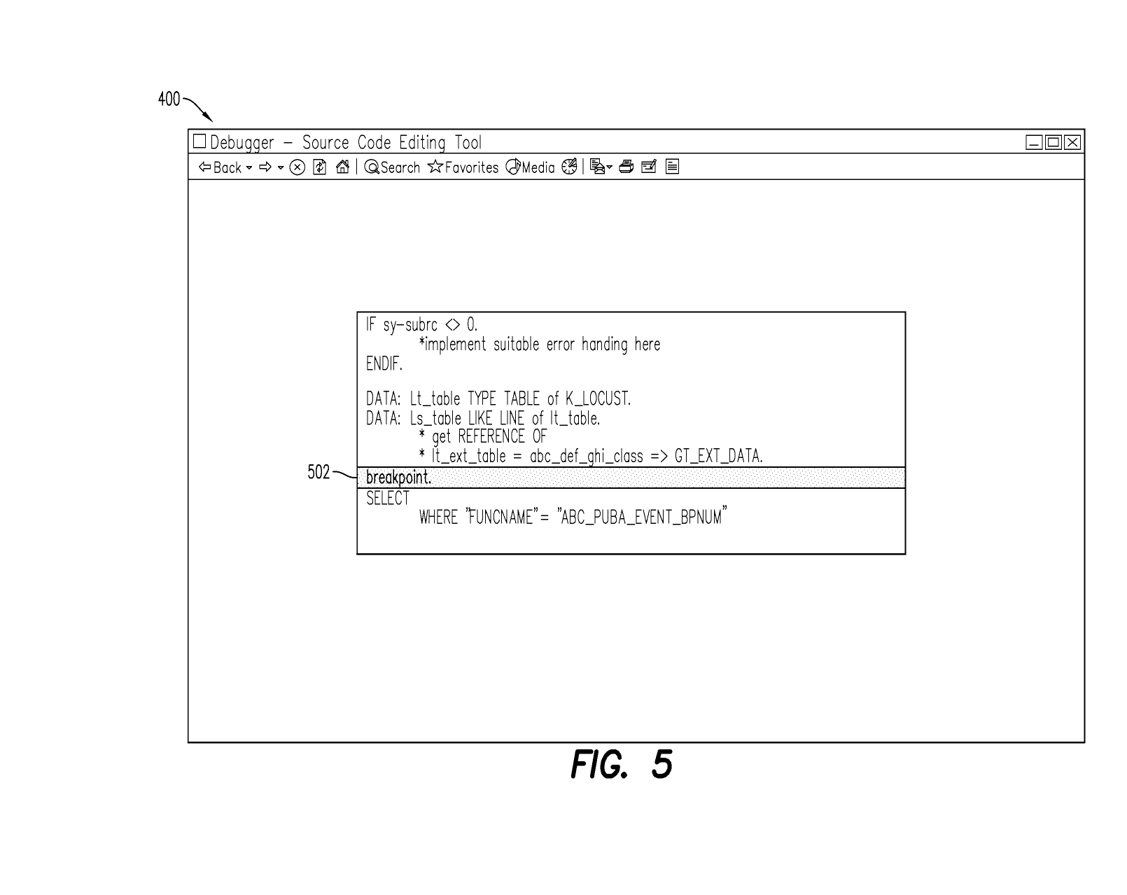

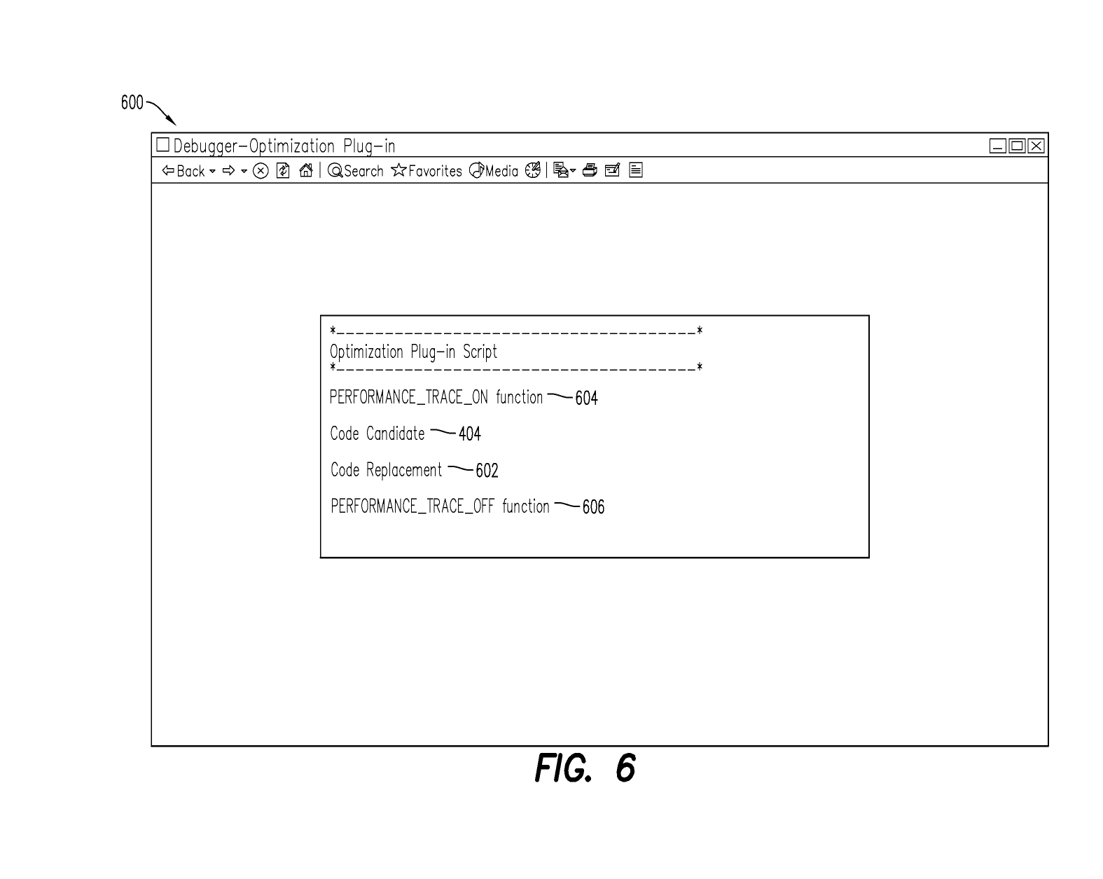

The debugger 224 may call the optimizer plug-in element 230 in response to requests received from the user 238 for optimization. For example, the user 238 may input a breakpoint 502 (FIG. 5) into an interface provided by the debugger 224 including a code block and request determination of an optimized code 602 (FIG. 6) (“code replacement”) for code following the breakpoint. The optimizer plug-in element 230 may access the template 232, which describes the code optimization, populate the template 232 with the query for code optimization and with the code following the breakpoint, and transmit, via the template 232, the code following the breakpoint to the text generation model 218 via the API proxy 216.

The optimizer plug-in element 230 creates a prompt consisting of a system prompt and a user prompt based on a system prompt template of template 232 and a user prompt template of prompt templates 232. The prompt includes the description, the metadata and instructions to decompose the code following the break into components for optimization. The prompt is provided to Application Programming Interface (API) proxy 216 of trained text generation model 218.

Text generation model 218 may comprise a neural network trained to generate text based on input text. Trained text generation model 218 may be implemented by, for example, executable program code, a set of hyperparameters defining a model structure and a set of corresponding weights, or any other representation of an input-to-output mapping which was learned as a result of the training.

According to some embodiments, model 218 is a large language model (LLM) conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of trained text generation model 218 include GPT-4, LaMDA, Claude or the like. Model 218 may be publicly available or deployed within a landscape which is trusted. Similarly, text generation model 218 may be trained based on public and/or private data.

Text generation model 218 generates a response based on the received prompt. The response may comprise, in natural language, optimized lines of code as a generated answer to the query.

The optimized code is returned to debugger 224. The debugger 224 then executes the optimized code in parallel with execution of the original code, and a metric is output for each. According to some embodiments, the debugger 224 applies syntactic and logical validations to the optimized code prior to execution of the original code and execution of the optimized code. The output for each of the executed optimized code and the executed original code may be presented to the trace analyzer 234. The trace analyzer 234 compares the output metrics and determines which code is closer to a pre-defined target value or threshold. The analysis output by the trace analyzer 234 is presented to user 238 via the UI system 212.

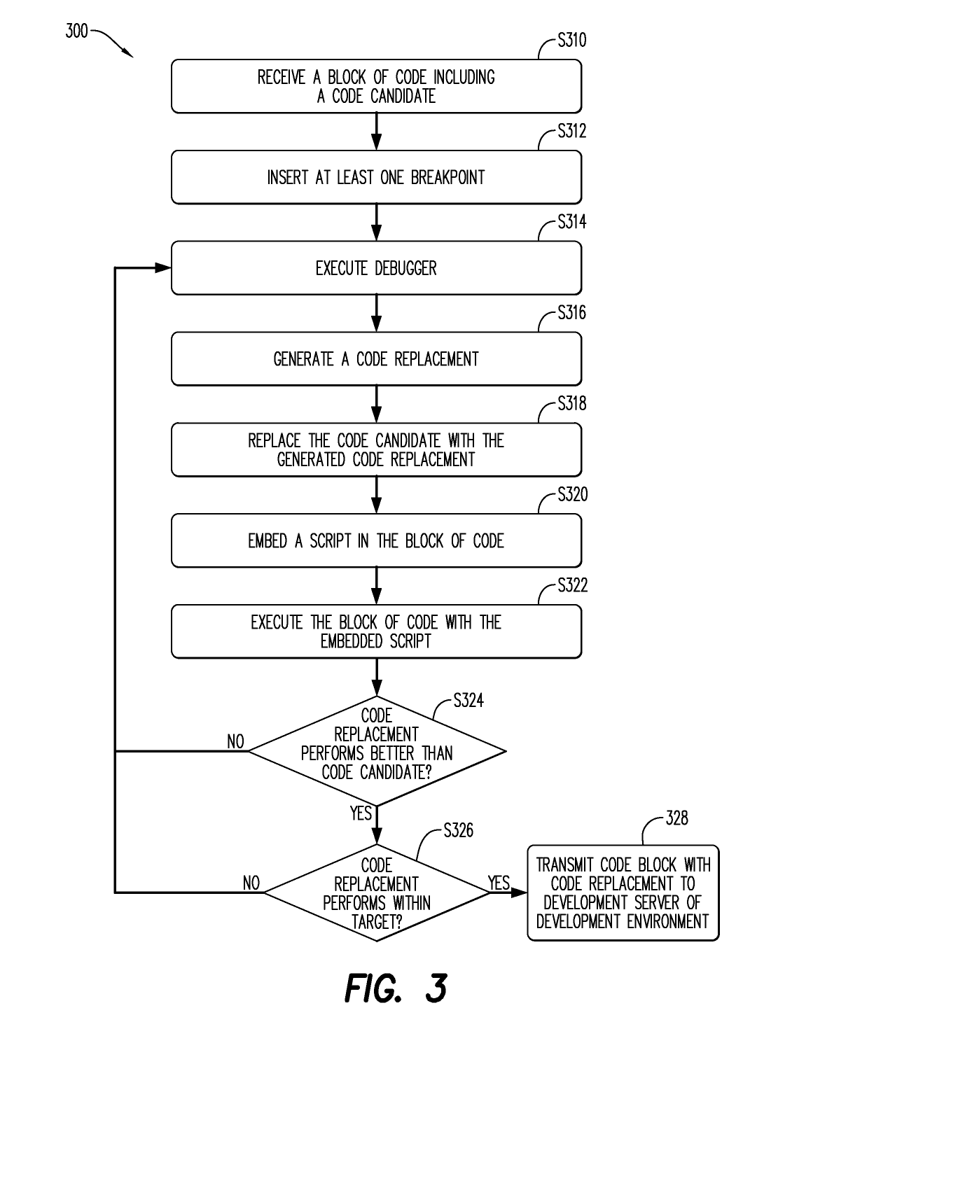

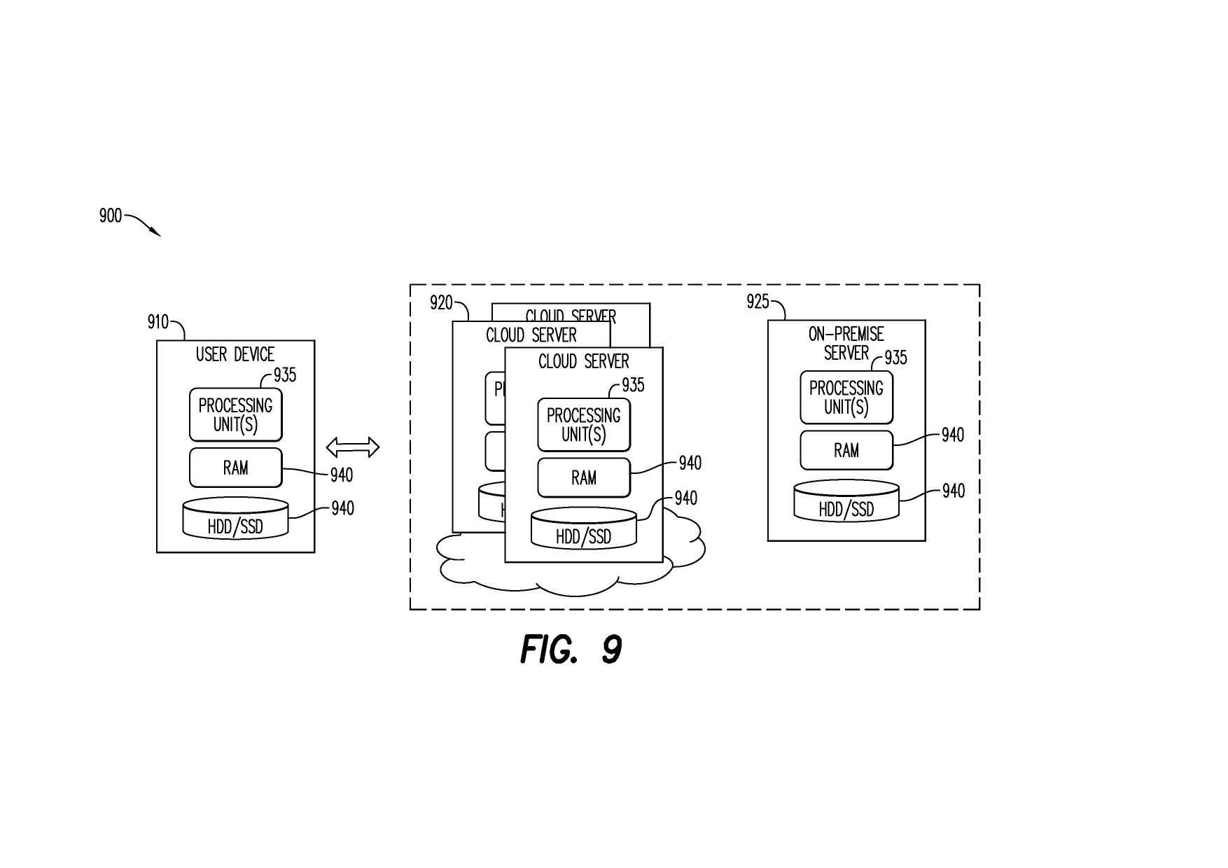

FIG. 3 illustrates a process 300 to generate an optimized code according to some embodiments. The process 300, and other processes described herein, may be performed by a database node, a cloud platform, a server, a computing system (user device), a combination of devices/nodes, or the like, according to some embodiments. In one or more embodiments, the system architecture 200 may be conditioned to perform the process 300, and other processes described herein, such that a processing unit 935 (FIG. 9) of the system architecture 200 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Prior to execution of the process, a code candidate is identified in a block of code. The code candidate is one or more lines of code representing a function or other statement that is under-performing with respect to a target value for at least one metric. Continuing with the non-exhaustive example described above, the metric is execution time (e.g., duration) and the target execution time for performance of function A is one second. The code candidate in this example has an execution time of four seconds for function A. The metric may be measured via execution of a performance trace. The performance trace may be the trace included in the debugger 224, or may be a separate trace. The performance trace may be an SQL trace or other suitable trace. Pursuant to embodiments, a test script is used to test the application under test. Initially, the trace is switched on, and then the test script is executed such that the trace tracks execution of the test script. After the test script has finished execution, the trace may be switched off manually or automatically. The output of the performance trace includes all executed statements of the test script in the order of execution, and may also include the performance parameter metrics for those executed statements. It is noted that one execution of a statement may result in several lines in a result list. The parameter metrics may include, but are not limited to, executions, duration and records. These metrics describe how often a statement was executed, how much time it needed in total for the execution and how many records were selected or changed, respectively. In the example described herein, the metric being analyzed is the duration metric, and per a developer-defined target threshold, the duration of this statement should be one second or less. A value greater than one second is an indication that there is a problem with the execution of that statement, or that the statement can be executed more efficiently. Based on the metrics, the code candidate is identified as the code performing worse than desired. Pursuant to embodiments, the code candidate may be identified manually by a developer, or may be identified automatically by the debugger 234 via the automatic comparison of the duration metric, for example, to a pre-defined target threshold. The output of the performance trace may also include a source code location (e.g., line number) for the beginning of each statement.

Also prior to execution of the process 300, a user may log-in to a code editing tool (“code editor”) and select a code candidate for optimization. Pursuant to embodiments, the code editor may be included in the debugger 224 or may be a separate tool.

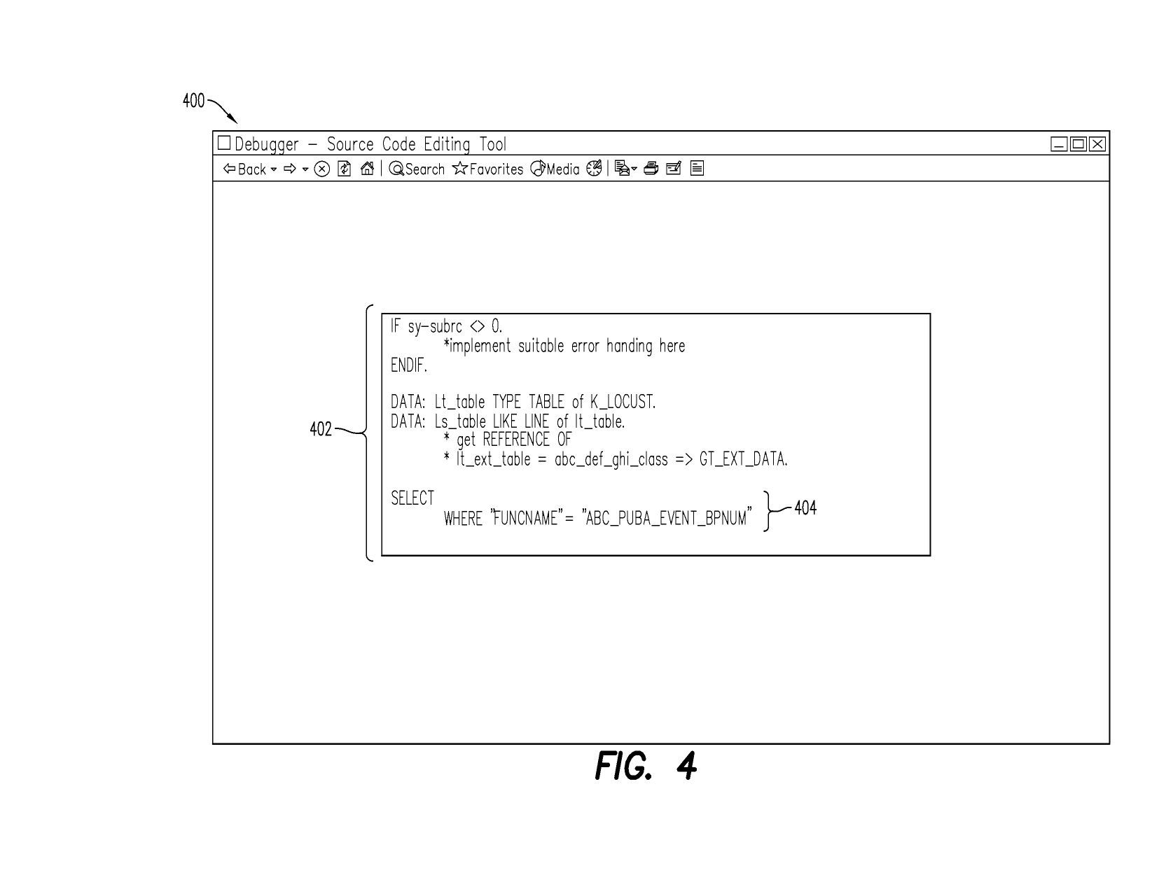

Initially, at S310 a block of code 402 (FIG. 4) including a code candidate 404 is received. The block of code 402 and the code candidate 404 may be received in the code editor in response to selection by the user. The block of code 402 may include one or more lines of code immediately preceding the code candidate and one or more lines of code immediately following the code candidate. As a non-exhaustive example, a user interface 400 in FIG. 4 displays a block of code 402 including the code candidate 504 represented by the statement “SELECT WHERE “FUNCNAME” = “ABC_PUBA_EVENT_BPNUM” in the code editor of the debugger 224.

Then at S312, at least one breakpoint 502 (FIG. 5) is inserted in the block of code 402 at a specific line in the block of code 402. The breakpoint 502 separates the code candidate 404 from other lines of code in the block of code 402. The breakpoint 502 is an instruction to the debugger 242 during execution thereof to pause execution of the debugger at this point. The breakpoint 502 indicates a place in the block of code where the code needs to be changed. Pursuant to embodiments, the breakpoint 502 pauses execution of the debugger and calls the plug-in element to generate a code replacement and execute an optimizer script as described further below. The breakpoint 502 may be inserted via at least one of: entry in the block of code of a textual breakpoint instruction, activation of a breakpoint icon, selection of a breakpoint setting, or other suitable breakpoint insertion process. Once the breakpoint 502 is inserted, it has an active status and may take effect during execution of the debugger 242. It is noted that the breakpoint may have an inactive status and will then be ignored at runtime of the debugger. It is further noted that, pursuant to embodiments, a single breakpoint may be inserted in the block of code at the specific line that separates an immediately preceding line of code from the code candidate, or two breakpoints may be inserted in the block of code – one at the specific line that separates the prior line of code from the code candidate, and one at the specific line that separates the last line of the code candidate from a following line of code in the block of code. Additionally, in one or more embodiments, multiple breakpoints may be inserted, indicating multiple places in the code for optimization for multiple code candidates.

After insertion of the breakpoint 502, the debugger 242 is executed at S314. The debugger is executed with the block of code including the code candidate and breakpoint.

During execution, the debugger 242 executes the block of code and reaches the breakpoint 502 and calls the plug-in element 230. It is noted that pursuant to some embodiments, the debugger executes for the block of code instead of the whole application under development to increase the speed of the process 300. The plug-in element 230 selects a prompt template 232 intended to prompt determination of optimized code as shown in Appendix A. The prompt of Appendix A describes a non-exhaustive example of a task of generating a code replacement for the code candidate. The plug-in element 230 populates the prompt template 232 with the code following the breakpoint 502. In a case there is only one breakpoint, all of the code following the breakpoint 502 is populated in the prompt template 232, including code that is not part of the code candidate (e.g., code that follows the code candidate). In a case there are two breakpoints, the code between the two breakpoints is populated in the prompt template 232. The plug-in element 230 then provides the populated prompt to the trained text generation model 218 via API proxy 216.

A code replacement for the code candidate 404 is generated at S316. It is noted that the code replacement is a replacement for all of the code populated in the prompt template 232. For example, in a case the code populating the prompt template includes code that is not part of the code candidate, the code replacement may include code that optimizes the code candidate and code that optimizes the code that is not part of the code candidate.

Text generation model 218 generates a response including the code replacement 602 (FIG. 6) based on the prompt and returns the response to the plug-in element 230. In some embodiments, the plug-in element 230 returns the response to the debugger 224, which returns the response to the UI system 212. The UI system 212 displays the response. The user may edit the proposed code replacement as needed. Alternatively, in some embodiments, after receipt of the response, the plug-in element 230 then automatically replaces the code candidate 404 with the code replacement 602 in S318. The replacement may be via insertion of the code replacement 602 into a script 600 (FIG. 6). The script 600 holds the code candidate 404 and the code replacement 602. In the script 600, the code candidate 404 and the code replacement 602 may be inserted between two functions: a Performance_Trace_On function 604 and a Performance_Trace_Off function 606. The script 600 is automatically embedded in the block of code 402 at the breakpoint 502 in S320.

Then, in S322, the block of code including the script 600 is executed in the debugger 224. When executed, the Performance_Trace_On function 604 and the Performance_Trace_Off function 606 trace the performance of two executions of the application under development 220 – one execution with the code candidate 404 and another execution with the code replacement 602. The execution with the code replacement 602 differs from the execution with the code candidate in that the code replacement 602 has replaced the code candidate 404 in the application under development. The two executions may occur at the same time, substantially the same time, or sequentially. Execution of the block of code including the script 600 outputs a trace result. As a trace result is output for each execution, the execution in S322 outputs a code replacement trace result 240 and a code candidate trace result 242.

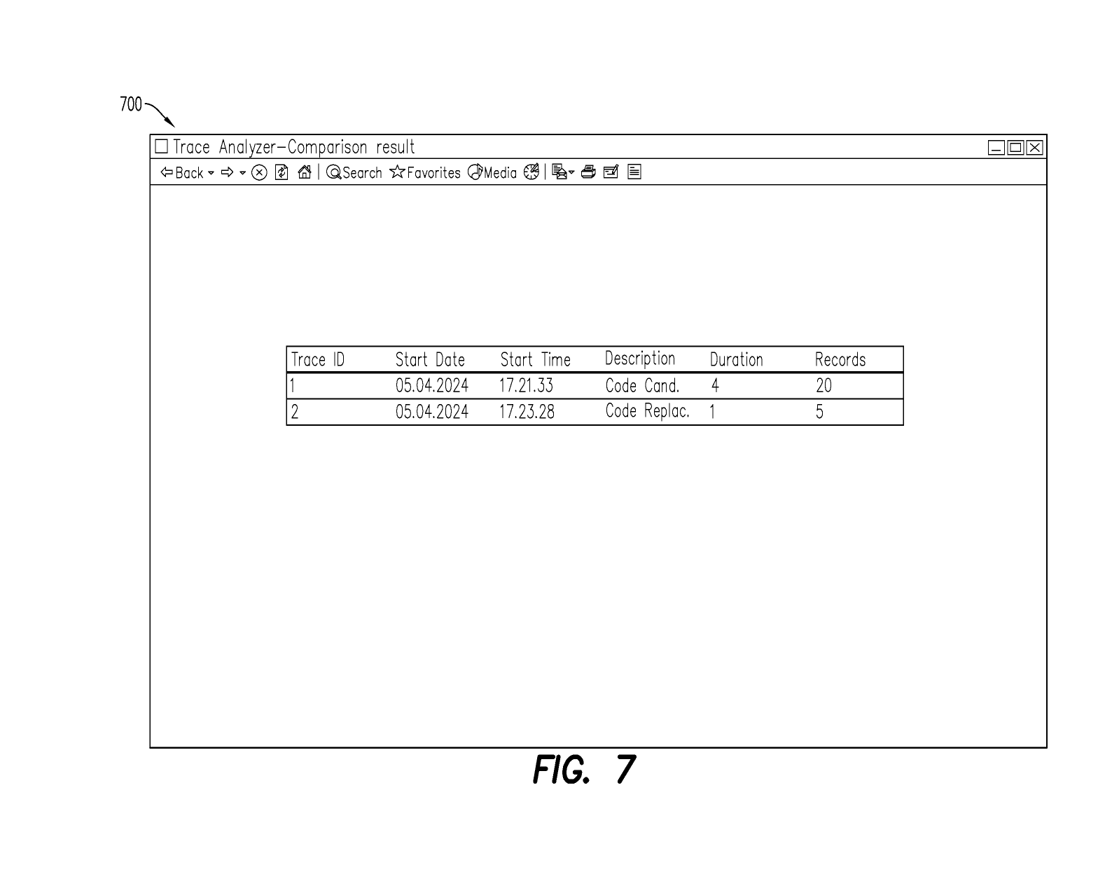

The code replacement trace result 240 and the code candidate trace result 242 are transmitted to the trace analyzer 234 for a comparative analysis in S324. In one or more embodiments, the analysis includes a comparison of the code replacement trace result 240 and the code candidate trace result 242. The comparison may determine whether the code replacement performs better than the code candidate. The trace analyzer 234 may output a trace analyzer comparison result user interface 700 as shown in the non-exhaustive example in FIG. 7.

In a case it is determined at S324 that the code replacement performs better than the code candidate, the code replacement trace result is compared to the pre-defined target threshold in S326 to determine whether the code replacement performs within the target.

In a case it is determined in S324 that the code replacement does not perform better than the code candidate, the process 300 returns to S314 and the code replacement is added to the previously-populated prompt template, and this updated template is provided to the trained text generate model 218 via the API proxy 216 to generate another optimized code replacement.

In a case it is determined at S326 that the code replacement is not under-performing compared to the pre-defined target threshold, the process 300 continues to S328 and the code block including the code replacement is transmitted to the development sever 204 of the development environment 202. In this way, only one change is sent to the development environment, instead of the conventional multiple changes. The application under development may then be updated with the code replacement, finalized and transmitted to the production environment as a live application.

In a case it is determined at S326 that the code replacement is under-performing compared to the pre-defined target threshold, the process 300 returns to S314 and the code replacement is added to the previously-populated prompt template, and this updated template is provided to the trained text generate model 218 via the API proxy 216 to generate another optimized code replacement.

Continuing with the non-exhaustive example described above, the code candidate trace result 242 includes a duration of four seconds, while the code replacement trace result 240 includes a duration of one second. At S324 it is determined the code replacement performs better than the code candidate, as for the duration metric, a shorter duration indicates better performance. For other metrics, greater or lesser values may indicate better performance. Then at S326 it is determined the code replacement does perform within the target, as the target was one second or less and the code replacement has a duration of one second. Based thereon, the code block including the code replacement is transmitted to the development server in S328. The code block including the code replacement may be transmitted as a stand-alone code block or may be transmitted as part of a version of an application under development.

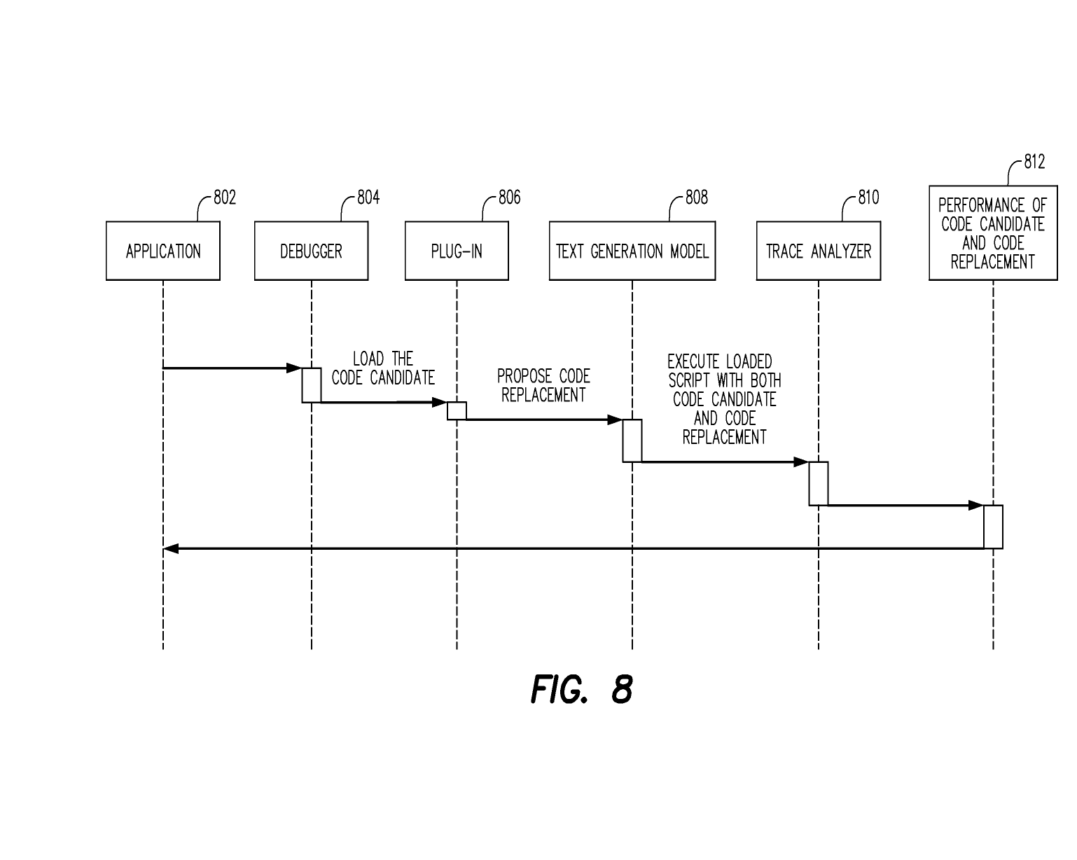

FIG. 8 is a sequence diagram 800 illustrating generation of a code replacement according to some embodiments. As illustrated, application under development 802 is transmitted to the debugger 804. The debugger 804 then loads the code candidate into the plug-in element 806. The plug-in element accesses – via the template – the text generation model 808. The text generation model (e.g., a generative AI model) 808 generates a proposed code replacement. Both the code candidate and the code replacement are loaded into the script, which is executed and the results are sent to the trace analyzer 810. The performance of the code candidate and the code replacement are compared 812, and in the code replacement is returned to the application under development 802.

FIG. 9 illustrates a cloud-based database deployment 900 according to some embodiments. The illustrated components may reside in one or more public clouds providing self-service and immediate provisioning, autoscaling, security, compliance and identity management features.

User device 910 may interact with applications executing on one of the cloud server 920 or the on-premise server 925, for example via a Web Browser executing on user device 910, in order to generate a code replacement. Cloud server 920 may comprise cloud-based compute resources, such as virtual machines, allocated by a public cloud provider. As such, cloud server 920 may be subjected to demand-based resource elasticity. Each of the user device 910, cloud server 920, and on-premise server 925 may include a processing unit 935 that may include one or more processing devices each including one or more processing cores. In some examples, the processing unit 935 is a multicore processor or a plurality of multicore processors. Also, the processing unit 935 may be fixed or it may be reconfigurable. The processing unit 935 may control the components of any of the user device 910, cloud server 920, and on-premise application server 925. The storage devices 940 may not be limited to a particular storage device and may include any known memory device such as RAM, ROM, hard disk, and the like, and may or may not be included within a database system, a cloud environment, a web server or the like. The storage device 940 may store software modules or other instructions/executable code which can be executed by the processing unit 935 to perform the method shown in FIG. 3. According to various embodiments, the storage device 940 may include a data store having a plurality of tables, records, partitions and sub-partitions. The storage device 940 may be used to store database records, documents, entries, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non- transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

### Appendix A

“You are a tool used to generate a code replacement for a code candidate.”

You are tasked with decomposing a provided code candidate into components needed to produce an optimized code replacement. The task is named CR_TASK. The code candidate to optimize is prefixed by a breakpoint and may or may not be suffixed by a breakpoint. To complete this task you will be provided:

* The code candidate

What is claimed is:

1. A system comprising:
a memory storing program code; and
one or more processing units to execute the program code to cause the system to:
receive a block of code including a code candidate;
insert at least one breakpoint in the block of code;
execute a debugger tool with the code candidate including the inserted at least one breakpoint, wherein the debugger tool is included in a pre-production environment;
generate a code replacement for the code candidate;
replace the code candidate with the code replacement;
automatically embed a code replacement script in the code block with the code replacement;
execute the code block including the code replacement script in the debugger tool, wherein execution of the code block outputs at least a code replacement trace result;
compare the code replacement trace result to a code candidate trace result; and
based on the comparison, transmit the code block including the code replacement to a development environment.

2. The system of claim 1, wherein the code candidate is identified via comparison of a code parameter to a threshold value.

3. The system of claim 2, further comprising program code to cause the system to:
execute a first trace during execution of an initial block of code, wherein the initial block of code includes one or more lines of code;
generate the code parameter based on the executed first trace;
identify one or more lines of code of the initial block of code as the code candidate based on the comparison of the code parameter to the threshold value.

4. The system of claim 3, wherein the code parameter is an execution duration parameter.

5. The system of claim 1, wherein the code candidate received at the debugger tool of the pre-production environment is received as part of an application under development from a development tool of the development environment.

6. The system of claim 1, wherein a first breakpoint of the at least one breakpoint is inserted in the code candidate at a line in the block of code that separates the code candidate from an immediately preceding line of code.

7. The system of claim 1, wherein the code replacement is generated via a generative artificial intelligence (GenAI) component.

8. The system of claim 1, wherein the code replacement trace script includes a trace-on function and a trace-off function.

9. The system of claim 8, wherein the code replacement script includes the code replacement and the code candidate between the trace-on function and the trace-off function.

10. The system of claim 9, wherein execution of the script initiates a first trace for the code replacement and a second trace for the code candidate.

11. A computer-implemented method comprising:
receiving a block of code including a code candidate;
inserting at least one breakpoint in the block of code;
executing a debugger tool with the code candidate including the inserted at least one breakpoint, wherein the debugger tool is included in a pre-production environment;
generating a code replacement for the code candidate;
replacing the code candidate with the code replacement;
automatically embedding a code replacement script in the code block with the code replacement, the code replacement script including a trace-on function and a trace-off function;
executing the code block including the code replacement script in the debugger tool, wherein execution of the code block outputs at least a code replacement trace result;
comparing the code replacement trace result to a code candidate trace result; and
based on the comparison, transmitting the code block including the code replacement to a development environment.

12. The method of claim 11, further comprising:
identifying the code candidate via comparison of a code parameter to a threshold value.

13. The method of claim 12, further comprising:
executing a first trace during execution of an initial block of code, wherein the initial block of code includes one or more lines of code;
generating the code parameter based on the executed first trace;
identifying one or more lines of code of the initial block of code as the code candidate based on the comparison of the code parameter to the threshold value.

14. The method of claim 13, wherein the code parameter is an execution duration parameter.

15. The method of claim 11, wherein the code replacement is generated via a generative artificial intelligence (GenAI) component.

16. The method of claim 11, wherein the code replacement script includes the code replacement and the code candidate between the trace-on function and the trace-off function.

17. The method of claim 16, wherein execution of the script initiates a first trace for the code replacement and a second trace for the code candidate.

18. One or more non-transitory, computer-readable medium storing instructions, that, when executed by a computing system, cause the computing system to perform operations comprising:
receiving a block of code including a code candidate;
inserting at least one breakpoint in the block of code;
executing a debugger tool with the code candidate including the inserted at least one breakpoint, wherein the debugger tool is included in a pre-production environment;
generating a code replacement for the code candidate;
replacing the code candidate with the code replacement;
automatically embedding a code replacement script in the code block with the code replacement, the code replacement script including a trace-on function and a trace-off function;
executing the code block including the code replacement script in the debugger tool, wherein execution of the code block outputs at least a code replacement trace result;
comparing the code replacement trace result to a code candidate trace result; and
based on the comparison, transmitting the code block including the code replacement to a development environment.

19. The medium of claim 18, wherein the code replacement is generated via a generative artificial intelligence (GenAI) component.

20. The medium of claim 18, wherein execution of the code replacement script initiates a first trace for the code replacement and a second trace for the code candidate.
